(19) United States
(12) Patent Application Publication
(10) Pub. No.: US 2006/0290673 A1
(43) Pub. Date: Dec. 28, 2006

(54) Bi-directional induction mouse component part

(75) Inventor: Hui-Pin Lian, Changhua City (TW)

Correspondence Address: TROXELL LAW OFFICE PLLC, SUITE 1404, 5205 LEESBURG PIKE, FALLS CHURCH, VA, 22041, US

(73) Assignee: Yankee Technology Co., Ltd.

(21) Appl. No.: 11/155,724

(22) Filed: Jun. 20, 2005

(51) Int. Cl. G09G 5/08

(52) U.S. Cl. 345/166

(57) ABSTRACT

A bi-directional induction mouse component part which uses the surface protruding points as monitoring points of optical inductor's coordinates, counter-weight balance fixed inside of photosphere produces barycenter and positioned downward, so that the body placing photosphere can rotate freely in X and Y axis, photosphere is elevated without any movement due to buoyancy of liquid or ball bearings, and the body drives optical inductor to induce surface of photosphere so that mouse controller control the movement of cursor; However, the body to place photosphere can be any type of control device (such as mouse or electric appliance controller, etc.), it can transmit signal on display or TV so as to remote-control all types of electric appliances, the body can be operated in air and on a plane position, furthermore, it can switch the inducing direction of optical inductor by transmitting and receiving LED and provide remote control body as basic modular of mouse.

### BACKGROUND OF THE INVENTION

1) Field of the Invention

This invention is a bi-directional induction mouse component part, which uses a photosphere inside the covered shell to remote-control the body is elevated by buoyancy of liquid or support of ball bearing, this photosphere faces downward forever based on barycenter of counter-weight balance, then the optical sensor inductor induces surface of photosphere so that body of mouse or controller and keyboard may be rotated in air or moved on desk, and switch upward or downward optical inductor by transmitting & receiving LED induction (determine to use the body on desk or hold in hand).

2) Description of the Prior Art

A common optical mouse (1) installs optical inductor (11) at side of the bottom of mouse body so that optical inductor (11) can induce bottom of mouse (12), (shown as FIG. 1-A), therefore, optical mouse (1) must be placed on a plane position to move along X and Y axis where it can control movement of cursor (shown as FIG. 1-B).

### SUMMARY OF THE INVENTION

1. Problem to be Solved
(1) A common mouse cannot move away from a plane position and control cursor in air, therefore, it can only be restricted on a plane position resulting in limited controllability.
(2) Because a common optical mouse must be placed on a plane position to control cursor via optical inductor, and absolutely cannot be elevated, so it is very difficult to integrate with other products.

2. Solution
(1) This invention applies photosphere with a build-in counter-weight balance, the photosphere will face downward forever with counter-weight balance as barycenter, then installs it in the covered shell of remote controller body, it may be elevated by the filled liquid or ball bearings, an upward optical inductor is fixed beneath center of the covered shell. This optical inductor may induce the displacement of coordinates over surface of photosphere, mouse controller transmits signal to the receiving modules of receiver through the transmitting modules of transmitter, micro-processing controller of the receiving modules reads data, then USB outputs instruction to control signal so that PC can control remote facilities.
(2) This remote controller identifies switch of optical inductor by transmitting and receiving LED, when upward optical inductor switches to downward optical inductor, it may provide the function of common mouse.

3. Achievements Reached by this Invention
(1) This controller can hold in hand and directly control the movement of cursor on TV or display.
(2) It can be used as a common cordless mouse via induction switch.
(3) Modular design of this invention can combine cordless mouse with any remote controller device so as to provide multiple controlling functions.

### BRIEF DESCRIPTION OF THE DRAWINGS

FIG. 1-A: Side view sketch map of common mouse

FIG. 1-B: Control sketch map of common mouse

FIG. 2: Modular drawing of this invention

FIG. 3: The Application sketch map of this invention for mouse

FIG. 4-A: Sketch map of static photosphere of this invention

FIG. 4-B: Sketch map of moving photosphere of this invention

FIG. 5-A: Sketch map of another static photosphere of this invention

FIG. 5-B: Sketch map of another moving photosphere

FIG. 6: Control system block diagram of this invention

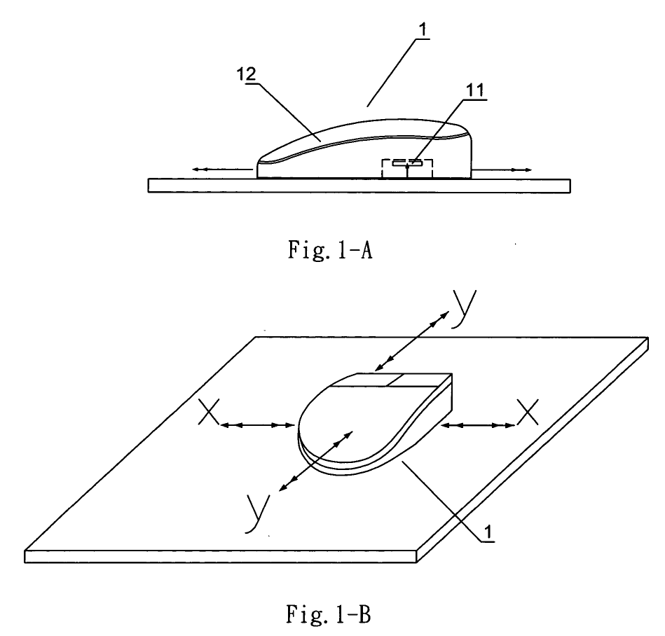

### DETAILED DESCRIPTION OF THE PREFERRED EMBODIMENTS

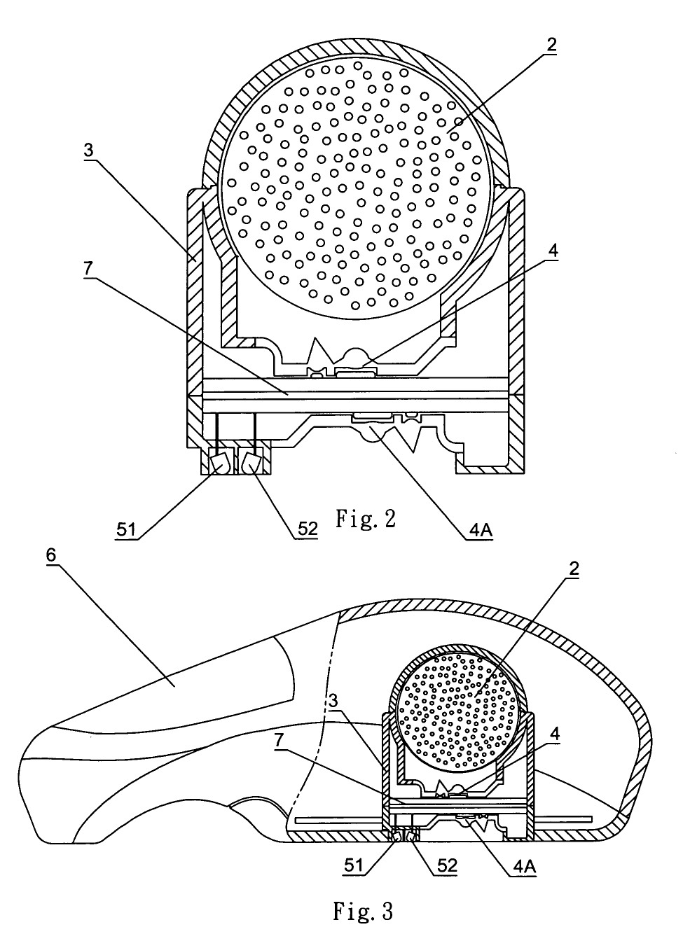

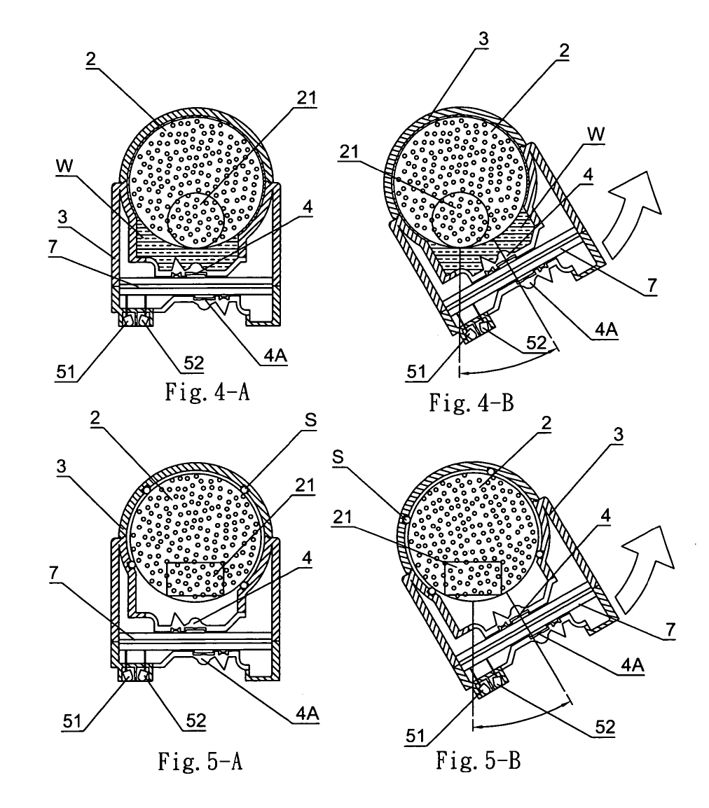

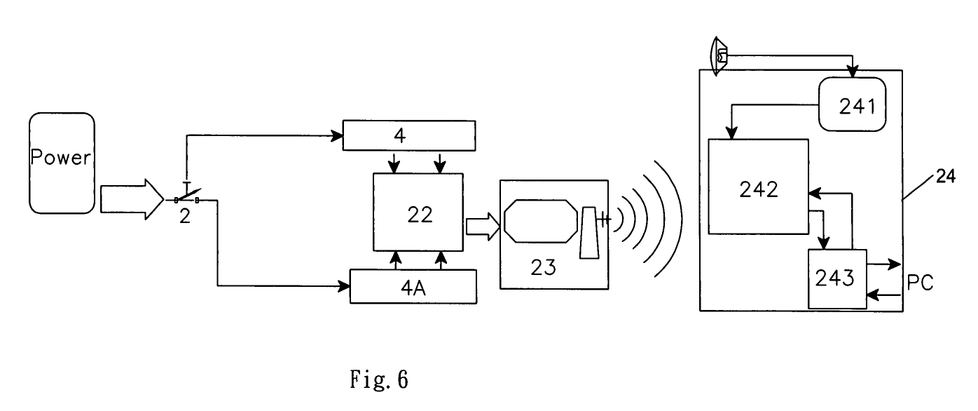

First, please refer to descriptions of figures, this invention assumes that photosphere 2 has counter-weight balance 21 which is put into a metal covered shell 3, fill liquid W into metal covered shell 3 or assumes there are numbers of ball bearing S (such as FIG. 4 or FIGS. 5-A and B) so as to make photosphere 2 float or elevate based on counter-weight balance 21 as barycenter and also photosphere 2 may face downward forever based on counter-weight balance 21 as barycenter; upward optical inductor 4 is fixed at the center beneath its counter-weight balance 21, and downward optical inductor 4A is fixed at the exposed position of shell 3, transmitter LED 51 and receiver LED 52 micro controlled by micro-processor 7 are fixed beneath one side of the exposed position of covered shell, transmitter LED 51 and receiver LED 52 may determine switch of upward or downward induction (refer to FIG. 2); Furthermore, please refer to descriptions of FIG. 3 [symbol] FIG. 4-A [symbol] FIG. 4 [symbol] B [symbol] FIG. 5-A [symbol] FIG. 5-B and FIG. 6, when transmitter LED 51 and receiver LED 52 switch over to upward optical inductor 4 according to induction determination, this optical inductor 4 monitors the surface of photosphere 2, its signal passes mouse controller 22, upward optical inductor 4 reads data, then calculates and revises the displacement of cursor or ignore the wrong signal of coordinates so as to input control signal to the remote receiver 24 by mouse signal transmitter 23. Its receiving modular 241 may transmit signal through receiving controller 242 and read data by micro-processor, then USB 243 transmits this control signal to PC so as to display cursor on TV set or display, at the same time, mouse 6 rotates in X & Y axis in the air, and photosphere 2 keeps vertically downward without any movement based on counter-weight balance as barycenter, this upward optical inductor 4 induces surface of photosphere in X & Y axis. Its signal may be transmitted to mouse controller 22 and read data from upward optical inductor 4, move cursor of mouse controller 22 to revise coordinates information and ignore wrong message, then output control signal via mouse signal transmitter 23, and this control signal is received by modular 241 of receiver 24, then receiving controller 242 reads data of modular 241. The control signal is transmitted to PC via USB 243 to control cursor on display (refer to FIG. 4-B, FIG. 5-B and FIG. 6) so as to provide network and operate the operational system, or uses as directly provide to controllers of all models of infrared electronic appliances; When transmitting & receiving LED 51 and 52 induction determination switches path to downward optical inductor 4A, so that the mouse 6 provides direct inducing over a plane position, its signal also reads data from downward optical inductor 4A at same time via mouse controller 22, and makes calculation revision on cursor displacement or ignore the wrong coordinates signal so as to output control signal and mouse signal transmitter 23 transmits this signal to remote cordless receiver 24 as a common mouse (as shown in FIG. 3, FIG. 4-A and FIG. 5-A).

What is claimed is:

1. The control methods of this bi-directional induction component part are as follows:
a. The photosphere of this mouse has a counter-weight balance, fixing inside a metal covered shell, barycenter of photosphere faces downward vertically by aerial positioning;
b. The optical inductor is fixed under barycenter of photosphere and induces surface of photosphere, control remote controller to rotate in X & Y axis in air, photosphere will not move due to barycenter facing down so that the induced signal may be output by mouse signal transmitter via mouse controller;
c. The receiving modular of receiver receives this mouse signal which is transmitted to PC via USB, the display may display this cursor and give all kinds of control instructions.
d. Switch the upward optical inductor to path of the downward optical inductor by transmitting LED and receiving LED induction determination so as to place this remote controller directly on a plane position and serve as common mouse.
Therefore, remote controller rotates in air, this optical inductor monitors surface of photosphere, cursor moves accordingly on display so as to provide remote control, and control screen to login on Internet and other jobs.

2. As control device of bi-directional induction mouse component part, its features are as follows:
(1) Photosphere is fixed inside the covered shell to remote-control the body, this photosphere has a built-in counter-weight balance so that it can face downward vertically based on counter-weight balance as barycenter, the elevated device inside the covered shell may support and position photosphere so that this photosphere won't rotate based on counter-weight balance as barycenter when remote-control the body to rotate.
(2) Optical inductor is fixed respectively beneath photosphere counter-weight balance and exposed position of covered shell, it induces upward to monitor surface of photosphere;
Micro-processor controls circuit to transmit and receive LED which is fixed beneath one side of exposed position of covered shell;
This remote control body can be any control device (mouse or electric appliance remote controller and keyboard), so that it can transmit signal directly on display or TV set.
Therefore, you can hold this remote control body in hand to rotate in air, and photosphere will not move based on its internal barycenter, so that this upward optical inductor monitors surface around photospheres, the remote control body can control cursor to move on screen in air, and operate functions.

3. As described in the item 2 of the scope of application for patent, the bi-directional induction mouse component part, thereof, the elevated device of photosphere is to fill liquid in the covered shell, elevate photosphere by buoyancy of liquid, and based on the counter-weight balance as barycenter so that photosphere won't rotate accordingly.

4. As described in item 2 of the scope of application for patent, the bi-directional induction mouse component part, thereof, the elevated device of this photosphere fixes many ball bearings inside the covered shell so as to position this photosphere and elevate it in container, based on the counter-weight balance as barycenter so that photosphere won't rotate accordingly.

5. As described in item 2 of the scope of application for patent, the bi-directional induction mouse component part, thereof, the upward or downward optical inductor of mouse can transmit and receive LED induction to determine monitoring position, so that this remote controller can be operated in air or on a plane position.
